(19) United States
(12) Patent Application Publication
(10) Pub. No.: US 2012/0263591 A1
(43) Pub. Date: Oct. 18, 2012

(54) SYSTEMS AND METHODS FOR ENHANCING PERFORMANCE OF WINDMILLS

(76) Inventor: YAT WAI EDWIN KWONG, Hong Kong (HK)

(21) Appl. No.: 13/088,366

(22) Filed: Apr. 17, 2011

(51) Int. Cl. F03D 7/04

(52) U.S. Cl. 416/9

(57) ABSTRACT

Systems and methods for enhancing performance of windmills. In one embodiment, a wind turbine system for enhancing performance of windmills is provided. The system includes a wind turbine assembly, which further includes a wind turbine attached to an upper end of a tower of the assembly. Further, a frame is attached to the upper end of the tower, which includes a plurality of mini windmills for purposes of wind detection. The mini windmills are oriented to detect the angular velocities of wind of which the windmills are facing into.

### FIELD OF THE INVENTION

This invention generally relates to systems and methods for enhancing performance of windmills. Specifically, but without limitation, this invention relates to using mini windmills to detect the most proper orientation of a wind turbine, in order to achieve greatest performance to general electricity.

### BACKGROUND OF THE INVENTION

Usually, mini turbines refer to smaller scale wind turbines to generate electricity. Such means of power generation is particular useful in remote, poor areas where a big wind farm cannot be employed. Across the planet, for example, 1.6 billion people lack access to electricity, and most of them in remote regions, and therefore new form of energy, such as wind power, can lead their lives according to the changing of the seasons, sunrise and sunset. As another example, in Peru, the technology has already brought light to some of the darkest corners of the country.

One challenge to deploy the smaller scale of wind generators is to determine where the turbines should be installed, in order to achieve the maximum efficiency of power generation. Further, given a fixed location, wind generators can be pointed at direction. A wind turbine, for example, can face North, or it can face South, East, West, or any direction of which wind is expected to direct and sail. A further challenge arises, as the strength of wind blow changes, in accordance to the weather, seasonal changes, and a wide variety of factors. Thus, wind turbines should be able to detect the optimal direction to receive wind blow. However, wind turbines are used to generate electricity and should not carry the responsibility of both generation and detection at the same time. Therefore, to maximize efficiency, there is a need for a separate device to detect the strength and direction of wind blow, before the wind turbine to adjust its direction after the detection is made.

### SUMMARY OF THE INVENTION

A wind turbine system is provided for enhancing performance of windmills. According to an embodiment of the invention, the system comprises a wind turbine assembly. The wind turbine assembly may be a device that generates energy from wind; a tower included in the wind turbine assembly; a wind turbine attached to an upper end of the tower.

Consistent with the embodiments of the invention, the wind turbine includes at least two rotor blades, the two rotor blades including GPS receivers to determine an angular velocity of the wind turbine; and an accelerometer included in the wind turbine to determine a direction of the wind turbine. The direction of which the wind turbine facing into the wind can be changed by turning the upper end of the tower freely; a frame mounted on the upper end of the tower, wherein a plurality of mini windmills are attached to the frame for purposes of wind detection; a first mini windmill mounted on the frame, with the first mini windmill facing at a first direction, wherein the first mini windmill includes at least two rotor blades, the two rotor blades including GPS receivers to determine an angular velocity of the first windmill.

An accelerometer may be included in the first mini windmill to determine a direction of which the first mini windmill is facing; a second mini windmill mounted on the frame, with the second mini windmill facing at a direction that is 90 degrees from the first direction. The second mini windmill includes at least two rotor blades, the two rotor blades including GPS receivers to determine an angular velocity of the second windmill; and an accelerometer included in the second mini windmill to determine a direction of which the second mini windmill is facing; a third mini windmill mounted on the frame, with the third mini windmill facing at a direction that is 90 degrees from the second direction.

In one aspect of the embodiments, the second mini windmill may include at least two rotor blades, the two rotor blades including GPS receivers to determine an angular velocity of the third windmill; and an accelerometer included in the third mini windmill to determine a direction of which the third mini windmill is facing; a fourth mini windmill mounted on the frame, with the fourth mini windmill facing at a direction that is 90 degrees from the third direction, wherein the third mini windmill includes at least two rotor blades, the two rotor blades including GPS receivers to determine an angular velocity of the fourth windmill; and an accelerometer included in the fourth mini windmill to determine a direction of which the fourth mini windmill is facing; a processor included in the wind turbine; and a memory included in the wind turbine, the memory storing instructions that cause the processor to execute a method.

The exemplary method may comprise as initialization, positioning the direction of each mini windmill; measuring the angular velocity of each mini windmill by using the GPS receivers included in each mini windmill; determining a mini windmill with a greatest angular velocity, in light of the measured angular velocity of each mini windmill; and in order to enhance performance of the wind turbine, turning the upper end of the tower to change the direction of the wind turbine to face at a same direction as the mini windmill with the greatest angular velocity, by using the accelerometer of the wind turbine.

### BRIEF DESCRIPTION OF THE DRAWINGS

FIG. 1 illustrates an exemplary system to enhance performance of windmills

### DETAILED DESCRIPTION

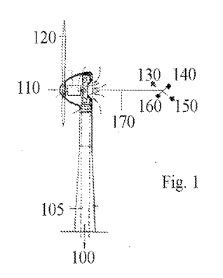

Systems and methods are provided to enhance performance of windmills. Referring to FIG. 1, one embodiment of the inventions include a wind turbine system, comprising a wind turbine assembly, wherein the wind turbine assembly is a device that generates energy from wind; a tower (100) included in the wind turbine assembly; a wind turbine attached to an upper end of the tower (100), wherein the wind turbine includes at least two rotor blades (120), the two rotor blades (120) including GPS receivers to determine an angular velocity of the wind turbine; and an accelerometer (110) included in the wind turbine to determine a direction of the wind turbine, wherein the direction of which the wind turbine facing into the wind can be changed by turning the upper end of the tower (100) freely; a frame (170) mounted on the upper end of the tower (100), wherein a plurality of mini windmills are attached to the frame (170) for purposes of wind detection; a first mini windmill (130) mounted on the frame (170), with the first mini windmill (130) facing at a first direction.

The first mini windmill (130), as disclosed herein, includes at least two rotor blades (120), the two rotor blades (120) including GPS receivers to determine an angular velocity of the first windmill; and an accelerometer (110) included in the first mini windmill (130) to determine a direction of which the first mini windmill (130) is facing; a second mini windmill mounted on the frame (170), with the second mini windmill facing at a direction that is 90 degrees from the first direction, wherein the second mini windmill includes at least two rotor blades (120), the two rotor blades (120) including GPS receivers to determine an angular velocity of the second windmill; and an accelerometer (110) included in the second mini windmill to determine a direction of which the second mini windmill is facing; a third mini windmill mounted on the frame (170), with the third mini windmill facing at a direction that is 90 degrees from the second direction, wherein the second mini windmill includes at least two rotor blades (120), the two rotor blades (120) including GPS receivers to determine an angular velocity of the third windmill; and an accelerometer (110) included in the third mini windmill to determine a direction of which the third mini windmill is facing; a fourth mini windmill mounted on the frame (170), with the fourth mini windmill facing at a direction that is 90 degrees from the third direction, wherein the third mini windmill includes at least two rotor blades (120), the two rotor blades (120) including GPS receivers to determine an angular velocity of the fourth windmill; and an accelerometer (110) included in the fourth mini windmill to determine a direction of which the fourth mini windmill is facing; a processor included in the wind turbine; and a memory included in the wind turbine, the memory storing instructions that cause the processor to execute a method, wherein the method comprises as initialization, positioning the direction of each mini windmill; measuring the angular velocity of each mini windmill by using the GPS receivers included in each mini windmill; determining a mini windmill with a greatest angular velocity, in light of the measured angular velocity of each mini windmill; and in order to enhance performance of the wind turbine, turning the upper end of the tower (100) to change the direction of the wind turbine to face at a same direction as the mini windmill with the greatest angular velocity, by using the accelerometer (110) of the wind turbine.

In an different implementation, the wind turbine system may comprises a wind turbine assembly, wherein the wind turbine assembly is a device that generates energy from wind; a tower (100) included in the wind turbine assembly; a wind turbine attached to an upper end of the tower (100), wherein the wind turbine includes at least two rotor blades (120), the two rotor blades (120) including GPS receivers to determine an angular velocity of the wind turbine; and an accelerometer (110) included in the wind turbine to determine a direction of the wind turbine, wherein the direction of which the wind turbine facing into the wind can be changed by turning the upper end of the tower (100) freely; a frame (170) mounted on the upper end of the tower (100), wherein a plurality of mini windmills are attached to the frame (170) for purposes of wind detection; a first mini windmill (130) mounted on the frame (170), with the first mini windmill (130) facing at a first direction, wherein the first mini windmill (130) includes at least two rotor blades (120), the two rotor blades (120) including GPS receivers to determine an angular velocity of the first windmill; and an accelerometer (110) included in the first mini windmill (130) to determine a direction of which the first mini windmill (130) is facing; a second mini windmill mounted on the frame (170), with the second mini windmill facing at a direction that is 90 degrees from the first direction, wherein the second mini windmill includes at least two rotor blades (120), the two rotor blades (120) including GPS receivers to determine an angular velocity of the second windmill; and an accelerometer (110) included in the second mini windmill to determine a direction of which the second mini windmill is facing; a third mini windmill mounted on the frame (170), with the third mini windmill facing at a direction that is 90 degrees from the second direction, wherein the second mini windmill includes at least two rotor blades (120), the two rotor blades (120) including GPS receivers to determine an angular velocity of the third windmill; and an accelerometer (110) included in the third mini windmill to determine a direction of which the third mini windmill is facing; a fourth mini windmill mounted on the frame (170), with the fourth mini windmill facing at a direction that is 90 degrees from the third direction.

The third mini windmill may alternatively include at least two rotor blades (120), the two rotor blades (120) including GPS receivers to determine an angular velocity of the fourth windmill; and an accelerometer (110) included in the fourth mini windmill to determine a direction of which the fourth mini windmill is facing; a processor included in the wind turbine; and a memory included in the wind turbine, the memory storing instructions that cause the processor to execute a method, wherein the method comprises as initialization, positioning the direction of each mini windmill; measuring the angular velocity of each mini windmill by using the GPS receivers included in each mini windmill; determining a mini windmill with a greatest angular velocity, in light of the measured angular velocity of each mini windmill; in order to enhance performance of the wind turbine, turning the upper end of the tower (100) to change the direction of the wind turbine to face at a same direction as the mini windmill with the greatest angular velocity, by using the accelerometer (110) of the wind turbine; monitoring the angular velocity of the wind turbine continuously; when the angular velocity slows down to a predetermined value, resetting the direction of the wind turbine, wherein the resetting includes re-determining a mini windmill with a next greatest angular velocity, in light of the measured angular velocity of each mini windmill; and in order to enhance performance of the wind turbine, re-turning the upper end of the tower (100) to change the direction of the wind turbine to face at a same direction as the mini windmill with the next greatest angular velocity, by using the accelerometer (110) of the wind turbine.

In yet another implementation, the wind turbine system for enhancing performance of windmills may comprise a wind turbine assembly, wherein the wind turbine assembly is a device that generates energy from wind; a tower (100) included in the wind turbine assembly; a wind turbine attached to an upper end of the tower (100), wherein the wind turbine includes at least two rotor blades (120), the two rotor blades (120) including GPS receivers to determine an angular velocity of the wind turbine; and an accelerometer (110) included in the wind turbine to determine a direction of the wind turbine, wherein the direction of which the wind turbine facing into the wind can be changed by turning the upper end of the tower (100) freely; a frame (170) mounted on the upper end of the tower (100).

Following the previous example, a plurality of mini windmills may be attached to the frame (170) for purposes of wind detection; a first mini windmill (130) mounted on the frame (170), with the first mini windmill (130) facing at a first direction, wherein the first mini windmill (130) includes at least two rotor blades (120), the two rotor blades (120) including GPS receivers to determine an angular velocity of the first windmill; and an accelerometer (110) included in the first mini windmill (130) to determine a direction of which the first mini windmill (130) is facing; a second mini windmill mounted on the frame (170), with the second mini windmill facing at a direction that is 90 degrees from the first direction, wherein the second mini windmill includes at least two rotor blades (120), the two rotor blades (120) including GPS receivers to determine an angular velocity of the second windmill; and an accelerometer (110) included in the second mini windmill to determine a direction of which the second mini windmill is facing; a third mini windmill mounted on the frame (170), with the third mini windmill facing at a direction that is 90 degrees from the second direction, wherein the second mini windmill includes at least two rotor blades (120), the two rotor blades (120) including GPS receivers to determine an angular velocity of the third windmill; and an accelerometer (110) included in the third mini windmill to determine a direction of which the third mini windmill is facing; a fourth mini windmill mounted on the frame (170), with the fourth mini windmill facing at a direction that is 90 degrees from the third direction, wherein the third mini windmill includes at least two rotor blades (120), the two rotor blades (120) including GPS receivers to determine an angular velocity of the fourth windmill; and an accelerometer (110) included in the fourth mini windmill to determine a direction of which the fourth mini windmill is facing; a processor included in the wind turbine; and a memory included in the wind turbine, the memory storing instructions that cause the processor to execute a method, wherein the method comprises as initialization, positioning the direction of each mini windmill; measuring the angular velocity of each mini windmill by using the GPS receivers included in each mini windmill; determining a mini windmill with a greatest angular velocity, in light of the measured angular velocity of each mini windmill; in order to enhance performance of the wind turbine, turning the upper end of the tower (100) to change the direction of the wind turbine to face at a same direction as the mini windmill with the greatest angular velocity, by using the accelerometer (110) of the wind turbine; monitoring the angular velocity of each of the mini windmill continuously; when the greatest angular velocity of the mini windmill is no longer fastest among rest of the mini windmills, resetting the direction of the wind turbine, wherein the resetting includes re-determining a mini windmill with a next greatest angular velocity, in light of the measured angular velocity of each mini windmill; and in order to enhance performance of the wind turbine, re-turning the upper end of the tower (100) to change the direction of the wind turbine to face at a same direction as the mini windmill with the next greatest angular velocity, by using the accelerometer (110) of the wind turbine.

The wind turbine system may further be modified to include a wind turbine assembly, wherein the wind turbine assembly is a device that generates energy from wind; a tower (100) included in the wind turbine assembly; a wind turbine attached to an upper end of the tower (100), wherein the wind turbine includes at least two rotor blades (120), the two rotor blades (120) including GPS receivers to determine an angular velocity of the wind turbine; and an accelerometer (110) included in the wind turbine to determine a direction of the wind turbine, wherein the direction of which the wind turbine facing into the wind can be changed by turning the upper end of the tower (100) freely; a frame (170) mounted on the upper end of the tower (100), wherein a plurality of mini windmills are attached to the frame (170) for purposes of wind detection; a first mini windmill (130) mounted on the frame (170), with the first mini windmill (130) facing at a first direction that is headed North, wherein the first mini windmill (130) includes at least two rotor blades (120), the two rotor blades (120) including GPS receivers to determine an angular velocity of the first windmill; and an accelerometer (110) included in the first mini windmill (130) to determine a direction of which the first mini windmill (130) is facing; a second mini windmill mounted on the frame (170), with the second mini windmill facing at a direction headed East, which is 90 degrees from the first direction, wherein the second mini windmill includes at least two rotor blades (120), the two rotor blades (120) including GPS receivers to determine an angular velocity of the second windmill; and an accelerometer (110) included in the second mini windmill to determine a direction of which the second mini windmill is facing; a third mini windmill mounted on the frame (170), with the third mini windmill facing at a direction headed South, which is 90 degrees from the second direction, wherein the second mini windmill includes at least two rotor blades (120), the two rotor blades (120) including GPS receivers to determine an angular velocity of the third windmill; and an accelerometer (110) included in the third mini windmill to determine a direction of which the third mini windmill is facing; a fourth mini windmill mounted on the frame (170), with the fourth mini windmill facing at a direction headed West, which is 90 degrees from the third direction, wherein the third mini windmill includes at least two rotor blades (120), the two rotor blades (120) including GPS receivers to determine an angular velocity of the fourth windmill; and an accelerometer (110) included in the fourth mini windmill to determine a direction of which the fourth mini windmill is facing; a processor included in the wind turbine; and a memory included in the wind turbine, the memory storing instructions that cause the processor to execute a method, wherein the method comprises, as initialization, positioning the direction of each mini windmill; measuring the angular velocity of each mini windmill by using the GPS receivers included in each mini windmill; determining a mini windmill with a greatest angular velocity, in light of the measured angular velocity of each mini windmill; in order to enhance performance of the wind turbine, turning the upper end of the tower (100) to change the direction of the wind turbine to face at a same direction as the mini windmill with the greatest angular velocity, by using the accelerometer (110) of the wind turbine; monitoring the angular velocity of each of the mini windmill continuously; when the greatest angular velocity of the mini windmill is no longer fastest among rest of the mini windmills, resetting the direction of the wind turbine, wherein the resetting includes re-determining a mini windmill with a next greatest angular velocity, in light of the measured angular velocity of each mini windmill; and in order to enhance performance of the wind turbine, re-turning the upper end of the tower (100) to change the direction of the wind turbine to face at a same direction as the mini windmill with the next greatest angular velocity, by using the accelerometer (110) of the wind turbine.

In yet another implementation, the wind turbine assembly may comprise a tower (100) included in the wind turbine assembly; a wind turbine attached to an upper end of the tower (100), wherein the wind turbine includes at least two rotor blades (120), the two rotor blades (120) including GPS receivers to determine an angular velocity of the wind turbine; and an accelerometer (110) included in the wind turbine to determine a direction of the wind turbine, wherein the direction of which the wind turbine facing into the wind can be changed by turning the upper end of the tower (100) freely; a frame (170) mounted on the upper end of the tower (100), wherein a plurality of mini windmills are attached to the frame (170) for purposes of wind detection; a mini windmill mounted on the frame (170), with the mini windmill facing at a direction, wherein the mini windmill includes at least two rotor blades (120), the two rotor blades (120) including GPS receivers to determine an angular velocity of the windmill; and an accelerometer (110) included in the first mini windmill (130) to determine the direction facing at the mini windmill, wherein the direction facing at the mini windmill can be changed by turning the mini windmill mounted on the frame (170); a processor included in the wind turbine; and a memory included in the wind turbine, the memory storing instructions that cause the processor to execute a method, wherein the method comprises as initialization, positioning the direction of the mini windmill; measuring the angular velocity of the mini windmill by using the GPS receivers included in the mini windmill; moving the mini windmill to different directions, by turning the mini windmill mounted on the frame (170), to measure the angular velocity for each of the moved direction; determining a direction of which a greatest angular velocity is obtained, in light of the measured angular velocity measured at each direction; in order to enhance performance of the wind turbine, turning the upper end of the tower (100) to change the direction of the wind turbine to face at the direction of which the greatest angular velocity of the mini windmill is obtained, by using the accelerometer (110) of the wind turbine; monitoring the angular velocity of the wind turbine continuously; when the angular velocity slows down to a predetermined value, resetting the direction of the wind turbine, wherein the resetting includes re-determining a direction of which a next greatest angular velocity is obtained, in light of the measured angular velocity measured at each direction; and in order to enhance performance of the wind turbine, re-turning the upper end of the tower (100) to change the direction of the wind turbine to face at the direction of which the next greatest angular velocity of the mini windmill is obtained, by using the accelerometer (110) of the wind turbine.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A wind turbine system for enhancing performance of windmills, comprising:
a wind turbine assembly, wherein the wind turbine assembly is a device that generates energy from wind;
a tower included in the wind turbine assembly;
a wind turbine attached to an upper end of the tower, wherein the wind turbine includes:
at least two rotor blades, the two rotor blades including GPS receivers to determine an angular velocity of the wind turbine; and
an accelerometer included in the wind turbine to determine a direction of the wind turbine, wherein the direction of which the wind turbine facing into the wind can be changed by turning the upper end of the tower freely;
a frame mounted on the upper end of the tower, wherein a plurality of mini windmills are attached to the frame for purposes of wind detection;
a first mini windmill mounted on the frame, with the first mini windmill facing at a first direction, wherein the first mini windmill includes:
at least two rotor blades, the two rotor blades including GPS receivers to determine an angular velocity of the first windmill; and
an accelerometer included in the first mini windmill to determine a direction of which the first mini windmill is facing;
a second mini windmill mounted on the frame, with the second mini windmill facing at a direction that is 90 degrees from the first direction, wherein the second mini windmill includes:
at least two rotor blades, the two rotor blades including GPS receivers to determine an angular velocity of the second windmill; and
an accelerometer included in the second mini windmill to determine a direction of which the second mini windmill is facing;
a third mini windmill mounted on the frame, with the third mini windmill facing at a direction that is 90 degrees from the second direction, wherein the second mini windmill includes:
at least two rotor blades, the two rotor blades including GPS receivers to determine an angular velocity of the third windmill; and
an accelerometer included in the third mini windmill to determine a direction of which the third mini windmill is facing;
a fourth mini windmill mounted on the frame, with the fourth mini windmill facing at a direction that is 90 degrees from the third direction, wherein the third mini windmill includes:
at least two rotor blades, the two rotor blades including GPS receivers to determine an angular velocity of the fourth windmill; and
an accelerometer included in the fourth mini windmill to determine a direction of which the fourth mini windmill is facing;
a processor included in the wind turbine; and
a memory included in the wind turbine, the memory storing instructions that cause the processor to execute a method.

2. The system of claim 1, wherein the method comprises:
as initialization, positioning the direction of each mini windmill;
measuring the angular velocity of each mini windmill by using the GPS receivers included in each mini windmill;
determining a mini windmill with a greatest angular velocity, in light of the measured angular velocity of each mini windmill; and
in order to enhance performance of the wind turbine, turning the upper end of the tower to change the direction of the wind turbine to face at a same direction as the mini windmill with the greatest angular velocity, by using the accelerometer of the wind turbine.

3. The system of claim 1, wherein the method comprises:
as initialization, positioning the direction of each mini windmill;
measuring the angular velocity of each mini windmill by using the GPS receivers included in each mini windmill;
determining a mini windmill with a greatest angular velocity, in light of the measured angular velocity of each mini windmill;
in order to enhance performance of the wind turbine, turning the upper end of the tower to change the direction of the wind turbine to face at a same direction as the mini windmill with the greatest angular velocity, by using the accelerometer of the wind turbine;
monitoring the angular velocity of the wind turbine continuously;
when the angular velocity slows down to a predetermined value, resetting the direction of the wind turbine, wherein the resetting includes:
re-determining a mini windmill with a next greatest angular velocity, in light of the measured angular velocity of each mini windmill; and
in order to enhance performance of the wind turbine, re-turning the upper end of the tower to change the direction of the wind turbine to face at a same direction as the mini windmill with the next greatest angular velocity, by using the accelerometer of the wind turbine.

4. The system of claim 1, wherein the method comprises:
as initialization, positioning the direction of the mini windmill;
measuring the angular velocity of the mini windmill by using the GPS receivers included in the mini windmill;
moving the mini windmill to different directions, by turning the mini windmill mounted on the frame, to measure the angular velocity for each of the moved direction;
determining a direction of which a greatest angular velocity is obtained, in light of the measured angular velocity measured at each direction;
in order to enhance performance of the wind turbine, turning the upper end of the tower to change the direction of the wind turbine to face at the direction of which the greatest angular velocity of the mini windmill is obtained, by using the accelerometer of the wind turbine;
monitoring the angular velocity of the wind turbine continuously;
when the angular velocity slows down to a predetermined value, resetting the direction of the wind turbine, wherein the resetting includes:
re-determining a direction of which a next greatest angular velocity is obtained, in light of the measured angular velocity measured at each direction; and
in order to enhance performance of the wind turbine, re-turning the upper end of the tower to change the direction of the wind turbine to face at the direction of which the next greatest angular velocity of the mini windmill is obtained, by using the accelerometer of the wind turbine.

5. A wind turbine system for enhancing performance of windmills, comprising:
a wind turbine assembly, wherein the wind turbine assembly is a device that generates energy from wind;
a tower included in the wind turbine assembly;
a wind turbine attached to an upper end of the tower, wherein the wind turbine includes:
at least two rotor blades, the two rotor blades including GPS receivers to determine an angular velocity of the wind turbine; and
an accelerometer included in the wind turbine to determine a direction of the wind turbine, wherein the direction of which the wind turbine facing into the wind can be changed by turning the upper end of the tower freely;
a frame mounted on the upper end of the tower, wherein a plurality of mini windmills are attached to the frame for purposes of wind detection;
a first mini windmill mounted on the frame, with the first mini windmill facing at a first direction that is headed North, wherein the first mini windmill includes:
at least two rotor blades, the two rotor blades including GPS receivers to determine an angular velocity of the first windmill; and
an accelerometer included in the first mini windmill to determine a direction of which the first mini windmill is facing;
a second mini windmill mounted on the frame, with the second mini windmill facing at a direction headed East, which is 90 degrees from the first direction, wherein the second mini windmill includes:
at least two rotor blades, the two rotor blades including GPS receivers to determine an angular velocity of the second windmill; and
an accelerometer included in the second mini windmill to determine a direction of which the second mini windmill is facing;
a third mini windmill mounted on the frame, with the third mini windmill facing at a direction headed South, which is 90 degrees from the second direction, wherein the second mini windmill includes:
at least two rotor blades, the two rotor blades including GPS receivers to determine an angular velocity of the third windmill; and
an accelerometer included in the third mini windmill to determine a direction of which the third mini windmill is facing;
a fourth mini windmill mounted on the frame, with the fourth mini windmill facing at a direction headed West, which is 90 degrees from the third direction, wherein the third mini windmill includes:
at least two rotor blades, the two rotor blades including GPS receivers to determine an angular velocity of the fourth windmill; and
an accelerometer included in the fourth mini windmill to determine a direction of which the fourth mini windmill is facing;
a processor included in the wind turbine; and
a memory included in the wind turbine, the memory storing instructions that cause the processor to execute a method, wherein the method comprises:
as initialization, positioning the direction of each mini windmill;
measuring the angular velocity of each mini windmill by using the GPS receivers included in each mini windmill;
determining a mini windmill with a greatest angular velocity, in light of the measured angular velocity of each mini windmill;
in order to enhance performance of the wind turbine, turning the upper end of the tower to change the direction of the wind turbine to face at a same direction as the mini windmill with the greatest angular velocity, by using the accelerometer of the wind turbine;
monitoring the angular velocity of each of the mini windmill continuously;
when the greatest angular velocity of the mini windmill is no longer fastest among rest of the mini windmills, resetting the direction of the wind turbine, wherein the resetting includes:
re-determining a mini windmill with a next greatest angular velocity, in light of the measured angular velocity of each mini windmill; and
in order to enhance performance of the wind turbine, re-turning the upper end of the tower to change the direction of the wind turbine to face at a same direction as the mini windmill with the next greatest angular velocity, by using the accelerometer of the wind turbine.
